(19) United States
(12) Patent Application Publication
(10) Pub. No.: US 2009/0246585 A1
(43) Pub. Date: Oct. 1, 2009

(54) CELL STRUCTURE OF FUEL CELL AND FUEL CELL STACK

(75) Inventors: Takao Kariya, Hino-shi (JP); Shuji Aoki, Yokohama-shi (JP); Akira Fujimoto, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/095,842

(22) PCT Filed: Aug. 24, 2007
(86) PCT No.: PCT/JP2007/066959

§ 371 Date: Jun. 2, 2008

(30) Foreign Application Priority Data
Aug. 29, 2006 (JP) 2006-232865

(51) Int. Cl. H01M 8/10

(52) U.S. Cl. 429/30

(57) ABSTRACT

There is provided a cell structure of a fuel cell which does not require a bolt, a seal member, or the like for fastening components of the fuel cell by a staked body, which can apply a stable fastening pressure to the entire surfaces of the components to reduce a contact resistance, and which can realize the down-sizing of the fuel cell; and a fuel cell stack. A cell structure of a fuel cell includes: a fuel cell component including at least an electrolyte membrane having reaction layers formed on both surfaces thereof and a member for allowing gas to diffuse and collecting current at a time of power generation; and an electrode substrate for taking out electric power, on which the fuel cell component is stacked, wherein the electrode substrate includes, as a structural portion for applying a surface pressure to the fuel cell component, a flow path or a closed space which is formed in the electrode substrate, for applying the surface pressure by allowing a fuel gas to flow in the flow path or the closed space.

### TECHNICAL FIELD

The present invention relates to a cell structure of a fuel cell and a fuel cell stack formed by stacking the cell structures.

### BACKGROUND ART

A fuel cell is drawing attention because use of the fuel cell enables to obtain an electric output several times to approximately ten times larger than that of a conventional battery per unit electrode area, and the fuel cell has a small load with respect to environment at a time of power generation.

Among the fuel cells, a polymer electrolyte fuel cell is suitable for a small electronic apparatus, especially for an apparatus which is portable for use, because the polymer electrolyte fuel cell is operated in a temperature range from normal temperature to 100° C., and a start-up time is short, and the electric output per unit electrode area is superior to the other fuel cells.

Power generation of the polymer electrolyte membrane fuel cell is performed as described below.

For the polymer electrolyte membrane, a perfluorosulfonic acid-based cation exchange resin is often used. As the membrane as described above, Nafion manufactured by DuPont is well known.

A power generation cell unit is formed of a membrane electrode assembly having a structure in which the polymer electrolyte membrane interposed between a pair of porous electrodes each bearing a catalyst made of platinum or the like, that is, a fuel electrode and an oxidizer electrode.

With respect to the power generation cell unit, an oxidizer and a fuel is supplied to the oxidizer electrode and the fuel electrode, respectively, thereby allowing protons to move in a polymer electrolyte membrane, whereby the power generation is performed. The power generation reaction is most effective when the power generation reaction is performed in a temperature range from about 60° C. to 100° C.

For the fuel cell for obtaining a large output, it is effective to employ hydrogen as a fuel. As a method of storing hydrogen, there are provided a method in which hydrogen is stored as a high-pressure gas by being compressed, a method in which hydrogen is stored as low-temperature liquid hydrogen, a method in which hydrogen is stored by using a hydrogen storage alloy, and a method in which methanol, gasoline, or the like is reformed to be converted into hydrogen for use.

However, the fuel cell as described above has to have a structural body having airtightness such that a leakage amount of the fuel such as hydrogen is small enough. As a result, restriction on design increases, so that it is difficult to downsize the structural body, thereby complicating an assembly process.

Further, when power generation is not performed, a temperature of the fuel cell is normal temperature, but at the time of power generation, the temperature thereof rises close to 100° C., so that components used for the fuel cell thermally expand and contract. Connection between fastening members is loosened or the fastening members are detached from each other due to thermal strain, thereby disabling to maintain the airtightness or causing a pressure applied to a surface of a stacked body (hereinafter, referred to as surface pressure). As a result, there arises such a problem that a contact resistance between components increases, thereby causing the reduction of power generation performance of the fuel cell.

In the fuel cell having a structure in which an electrolyte membrane, a catalyst, a member for supporting them, and the like are stacked, as a structural body for preventing the reduction of the surface pressure, there is conventionally known a structural body as illustrated in FIG. 11.

In the fuel cell as illustrated in FIG. 11, a cell unit 113 includes a power generation reaction portion 111 having reaction catalysts formed on both surfaces of a polymer electrolyte membrane, and support members 112 for supporting the power generation reaction portion 111 therebetween.

The plurality of cell units 113 are stacked to constitute a stack 114. End plates 116 for pressing and supporting the stack 114 are arranged on upper and lower ends of the stack 114. Bolts 117 and compression springs 118 are employed for fastening to pressurize the stack 114.

However, in a fuel cell structure of FIG. 11, a fastening force becomes weak in a portion between the bolts pressing the end plates.

With regard to this, in a conventional example as illustrated in FIG. 12, a surface pressure generating function portion 119 is inserted between the stack 114 and each of the end plates 116, thereby preventing surface pressure reduction in the portion between the bolts.

Examples of the surface pressure generating function portions 119 include members which are bulged by a pressurized fluid, members employing a spring material, and members having convex portions on centers thereof which support the stack 114 therebetween so as to allow the convex portions to face the stack 114.

Further, as a structure for preventing reduction of the surface pressure as described above, Japanese Patent Application Laid-Open No. H06-68898 discloses a method of generating a pressure for fastening a stack 136 through surface pressure generating plates 131 as illustrated in FIG. 13.

In this method, in the fuel cell obtained by stacking unit fuel cells 132 each of which is interposed between separators 130, a space 133 and the surface pressure generating plates 131 are provided in each of the separators 130.

A fluid flowing in from a fluid inlet hole 134 expands in the space 133, thereby generating a pressure for fastening the stack 136 through the surface pressure generating plates 131.

On the other hand, Japanese Patent Application Laid-Open No. 2003-272662 discloses a fuel cell in which a structure for supporting a power generation body is formed of an electronic substrate material, and the structure can be directly mounted on an electronic substrate.

However, in the conventional structural body as illustrated in FIG. 11, in order to support the whole stack with a uniform pressure, it is necessary to increase strength of the end plate by increasing a thickness thereof. When the strength of the end plate is insufficient, the fastening force in the portion between the bolts is weak. Therefore, a contact resistance of the components stacked in the subject portion increases, and at the same time, a pressing pressure of a seal member (gasket, O-ring, or the like) decreases, so it is difficult to maintain the airtightness.

Further, in a conventional example as illustrated in FIG. 12, in order to prevent reduction in a fastening force in the portion between the bolts, it is necessary to incorporate, between each of the end plates and the stack, a mechanism for generating a surface pressure. Thus, a certain thickness of the end plate, a certain thickness of the surface pressure generating mechanism, and a plurality of components are required, so it is difficult to downsize the fuel cell.

Further, in Japanese Patent Application Laid-Open No. H06-68898, in the separator, a pressing plate for generating a surface pressure and a space are required, and a piping and a presser device for leading a fluid to the space are required to be set separately, resulting in inhibiting down-sizing of the fuel cell.

Further, in Japanese Patent Application Laid-Open No. 2003-272662, there is disclosed that the fuel cell can directly be mounted on the electronic substrate, but there is given no consideration for generating the fastening force between the fuel cell components to reduce the contact resistance.

The present invention has been made in view of the above-mentioned problems, and an object of the present invention is to provide a cell structure of a fuel cell, which is constructed of a stacked body including a polymer electrolyte membrane having reaction layers formed on both surfaces thereof, in which a bolt, a seal member, or the like is not necessary for fastening fuel cell components by the stacked body, and a contact resistance can be reduced by applying a stable fastening pressure to the entire surfaces of the components, whereby the down-sizing of the cell structure of a fuel cell; and the fuel cell stack.

### DISCLOSURE OF THE INVENTION

The present invention provides a cell structure of a fuel cell and a fuel cell stack which are structured as described below.

A cell structure of a fuel cell according to the present invention includes: a fuel cell component including at least an electrolyte membrane having reaction layers formed on both surfaces thereof and a member for allowing gas to diffuse and collecting current at a time of power generation; and an electrode substrate for taking out electric power, on which the fuel cell component is stacked, in which the electrode substrate includes a structural portion for applying a surface pressure to the fuel cell component.

Further, in the cell structure of a fuel cell according to the present invention, the structural portion for applying the surface pressure can be a flow path, which is formed in the electrode substrate, for applying the surface pressure by allowing a fuel gas to flow in the flow path.

Further, in the cell structure of a fuel cell according to the present invention, the structural portion for applying the surface pressure can be a closed space, which is formed in the electrode substrate, for applying the surface pressure by allowing a fuel gas to flow in the closed space.

Further, in the cell structure of a fuel cell according to the present invention, a unit for adjusting a flow rate of the fuel gas can be provided at a flow communication opening for leading the fuel gas to the reaction layers from one of the flow path and the closed space.

Further, in the cell structure of a fuel cell according to the present invention, the electrode substrate can include a flexible plate-shaped member having at least one of a wiring pattern and a flow path formed thereon.

Further, in the cell structure of a fuel cell according to the present invention, the electrode substrate can include an aluminum substrate having at least one of a wiring pattern and a flow path formed thereon.

Further, in the cell structure of a fuel cell according to the present invention, the electrode substrate can be formed by bonding a plurality of the plate-shaped members.

Further, a fuel cell stack according to the present invention includes a plurality of cell structures of fuel cells as described above, in which the plurality of cell structures are stacked.

According to the present invention, in the cell structure of a fuel cell including the stacked body including the polymer electrolyte membrane provided with reaction layers formed on both surfaces thereof, without providing a new surface pressure generating member, the contact resistance can be reduced by applying the stable fastening pressure to the entire surfaces thereof. As a result, the cell structure of a small fuel cell and the fuel cell stack using it can be realized.

Further features of the present invention will become apparent from the following description of exemplary embodiments with reference to the attached drawings

### BRIEF DESCRIPTION OF THE DRAWINGS

FIG. 1 is a sectional view for illustrating a structural example of a fuel cell provided with a cell structure according to Example 1 of the present invention.

FIG. 2 is a sectional view for illustrating a structural example in which a part of components of the fuel cell of FIG. 1 according to Example 1 of the present invention are changed.

FIG. 3 is a schematic perspective view of the cell structure of the fuel cell and a casing for covering the cell structure according to Example 1 of the present invention.

FIG. 4 is a sectional view for illustrating a structural example of a fuel cell provided with a cell structure according to Example 2 of the present invention.

FIG. 5 is a sectional view of a single cell of a fuel cell in a case where a cell structure of the fuel cell according to Example 3 of the present invention is used in a stack.

FIG. 6 is an exploded perspective view of the single cell of the fuel cell as illustrated in FIG. 5 according to Example 3 of the present invention.

FIG. 7 is an exploded sectional view of components in a case where the cell structures of the fuel cell according to Example 3 of the present invention are stacked in several stages.

FIG. 8 is a schematic perspective view of a casing for covering the stack obtained by stacking the cell structures of the fuel cell according to Example 3 of the present invention.

FIG. 9 is a schematic perspective view of a state where the stack is accommodated in the casing according to Example 3 of the present invention.

FIG. 10 is a sectional view for illustrating a modified example of a cell structure of a fuel cell according to Example 4 of the present invention for use in a stack.

FIG. 11 is a schematic view for illustrating a fuel cell including conventional cell structures stacked to constitute a stack, in which fastening pressurization of end plates is performed by using bolts and compression springs.

FIG. 12 is a schematic view for illustrating the fuel cell including conventional cell structures stacked to constitute a stack, in which a surface pressure generating function portion is inserted between the end plate and the stack, thereby performing the fastening pressurization.

FIG. 13 is a schematic view for illustrating the fuel cell including conventional cell structures stacked to constitute a stack, in which surface pressure generating plates and a space are provided in each of separators, and a pressurized fluid is fed to the space, thereby performing the fastening pressurization.

### BEST MODE FOR CARRYING OUT THE INVENTION

Best modes for carrying out the present invention will be described in the following examples.

Hereinafter, examples of the present invention will be described.

### EXAMPLE 1

In Example 1, a description will be made of a structural example of a fuel cell including a cell structure of the fuel cell, to which the present invention is applied.

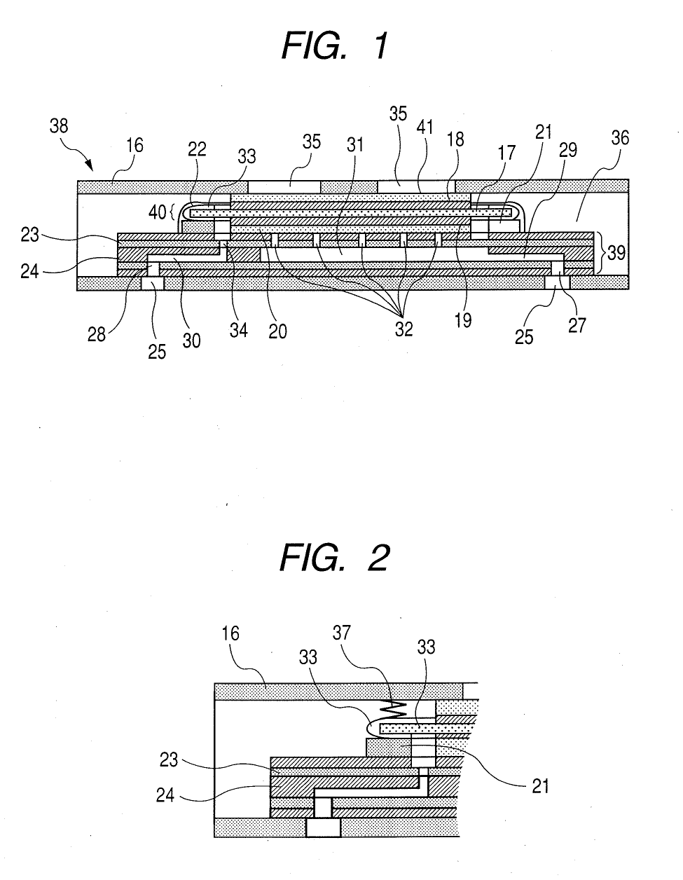

FIG. 1 illustrates a sectional view for describing a structure of the fuel cell of this example.

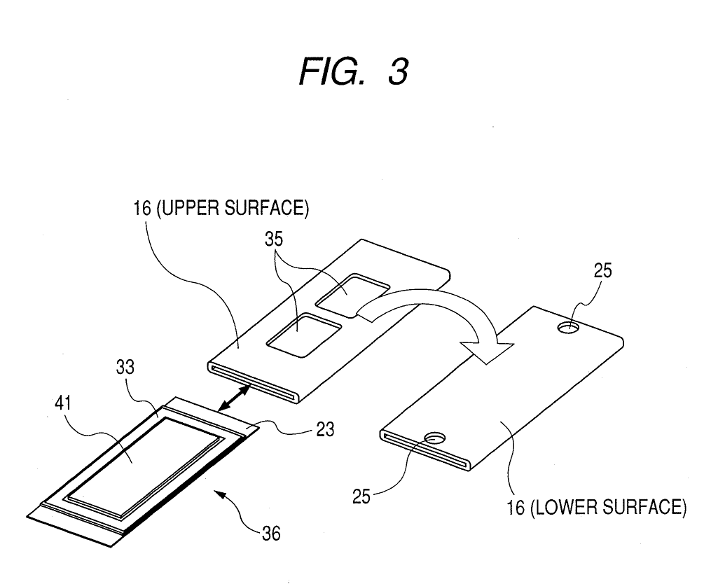

Further, FIG. 2 illustrates a schematic sectional view in a case where a part of components are changed. FIG. 3 illustrates a schematic perspective view of a fuel cell unit and a casing for covering the fuel cell unit according to this example.

In FIGS. 1 and 2, there are provided a casing 16, a polymer electrolyte membrane 17, reaction layers 18 and 19, a gas diffusion layer 20, a spacer 21, a fixing member 22, and substrates 23 and 24.

Further, there are provided flow communication openings 25, a flow communication opening 27, a flow communication opening 28, a flow path 29, a flow path 30, a flow path 31, flow communication openings 32, a metal layer 33, a flow communication opening 34, and opening portions 35.

There are also provided a fuel cell unit 36, a support member 37, a fuel cell 38, an electrode 39, a polymer electrolyte membrane 40 having the reaction layers formed on both surfaces thereof (hereinafter, referred to as MEA 40), and a gas diffusion layer 41.

In the fuel cell unit 36 (hereinafter, referred to as cell unit 36) of this example, the electrode 39 for taking out electric power (hereinafter, referred to as electrode 39) has the following structure.

That is, in the structure, the substrate 24 having, formed therein, the flow paths 29 and 30 through which a fuel gas flows, the flow communication openings 27 and 28, and the flow path 31 for generating a surface pressure is bonded to the substrate 23 having, formed therein, the flow communication openings 32 and 34.

Examples of a material of the substrates 23 and 24 include a flexible substrate made of polyimide and having conductive layers formed on both surfaces thereof, a ceramic substrate, an aluminum substrate, and a silicon substrate which have a flow path or a wiring pattern formed thereon.

In this example, there are preferably used polyimide flexible substrates which are flexible and can be obtained at low costs.

Further, examples of a method of bonding the substrates include blazing, ultrasonic bonding, and adhesion. Among those, soldered bonding, that is, blazing, which can be performed at low cost and allows easy disassembly afterward is preferable.

As a result, a need for a sealing member and component accuracy for maintaining airtightness are eliminated.

Further, electric conduction between both surfaces of the substrate is ensured by a through hole and a via (not shown).

The gas diffusion layers 20 and 41 each have a function of diffusing a gas which flows therein and as a current collecting member. A preferable material of the gas diffusion layers is a carbon material having a form of a non-woven fabric.

In order to prevent the fuel gas, which has flowed in from the electrode 39, from leaking out to an atmosphere, the metal layer 33 is formed in the vicinity of an outer periphery of the polymer electrolyte membrane 17.

The metal layer 33 may have a structure in which the metal layer is formed by plating, sputtering, or the like, or a thin metal foil is swaged.

The spacer 21 is a member for adjusting heights of the electrode 39 and the MEA 40.

On the electrode 39 structured as described above, the cell unit 36 is constructed of a staked body including the gas diffusion layer 20, the MEA 40, the spacer 21, and the gas diffusion layer 41 which are stacked on each other.

The electrode 39, the spacer 21, and the MEA 40 can be bonded to each other by the above-mentioned bonding or adhesion.

As a result, the components required for sealing is not required, so a need to give consideration to the component accuracy thereof can be eliminated.

The adhesive 22 can be used for more tightly fixing the stacked components. In place of the adhesive 22, as illustrated in FIG. 2, the support member 37 can be inserted between the cell unit 36 and the casing 16. Examples of a material of the support member 37 include a spring material, a metal material, and a chemical material. Of those, the spring material capable of dealing with elastic displacement is preferable.

The cell unit 36 structured as described above is put in the hollow casing 16 having the flow communication openings 25 and the opening portions 35 formed therein as illustrated in FIG. 3, thereby constituting the fuel cell 38.

After the cell unit 36 is put in the casing 16, in order to prevent the cell unit 36 from sticking out of the casing 16, holes on side surfaces of the casing 16 can be closed by, for example, tapes, detachable lids, metal plate swaging, adhesive, or welding. In this case, the tapes or the detachable lids are preferable because the fuel cell unit 36 can be taken out afterward.

A function of the fuel cell unit of this example described above will be described with reference to FIG. 1.

A fuel gas flowing in from the flow communication openings 25 and 27 illustrated in FIG. 1 reaches the flow path 31 through the flow path 29.

The fuel gas flowing in from the flow communication openings 25 and 27 is led from a fuel tank (not shown).

An example of a storage method of the fuel tank is given as a method using a hydrogen storage alloy. For example, a preferable material thereof is LaNi₅ having a release pressure at normal temperature of 0.2 MPa. Due to a pressure of the fuel gas which has reached the flow path 31, upper and lower surfaces bulge, thereby pressing the stacked gas diffusion layer 20 and MEA 40 to an inner wall of the casing 16 to generate a fastening force.

As a result, a uniform pressure can be applied by the entire surfaces. Thus, a contact resistance can be reduced.

Further, the fuel gas passes through the flow communication openings 32 and reaches the reaction layer 19 through the gas diffusion layer 20, and reacts with oxygen flowed in from the opening portions 35, to thereby start power generation and flows out to the outside through the flow communication opening 34, the flow path 30, and the flow communication opening 25.

At this time, a conductance for increasing the pressure in the flow path 31 is preferably maintained in such a relationship that a pressure in the flow path 29 is larger than a pressure in the flow communication opening 34, and the pressure in the flow communication opening 34 is larger than a pressure in the flow communication opening 32.

As a result, the fuel gas spreads over the entire surfaces, thereby applying the surface pressure. Further, according to the structure of this example, when the cell unit 36 is taken out of the casing 16, only by cutting off inflow of the fuel gas, the bulge is eliminated. Accordingly, the cell unit 36 can easily be taken out.

### EXAMPLE 2

In Example 2 of the present invention, a description will be made of a structural example of a cell structure of a fuel cell, in which a structure of a portion where a surface pressure is generated is different from that of Example 1.

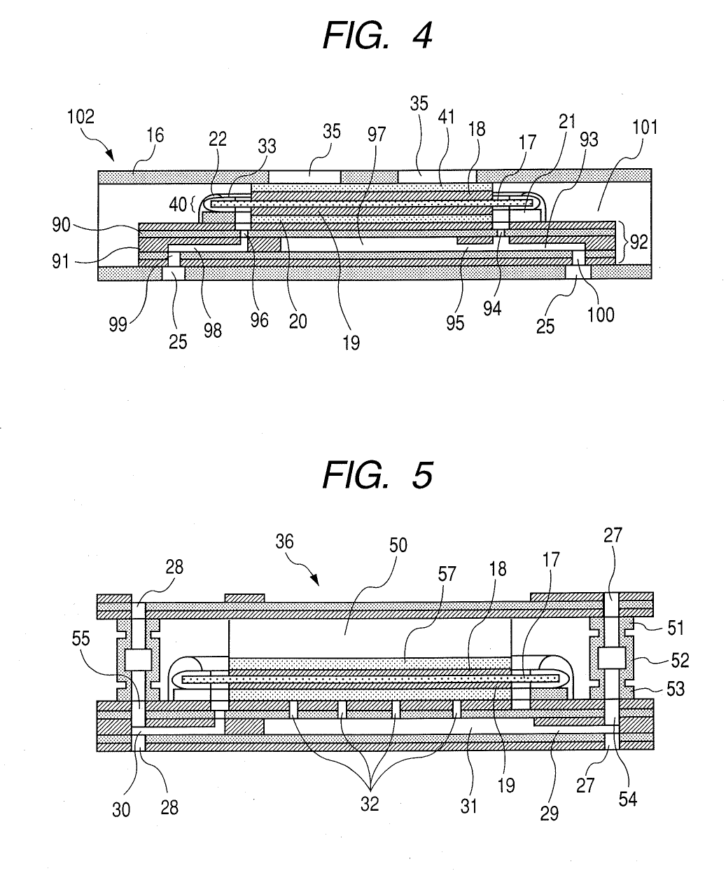

FIG. 4 illustrates a sectional view for describing the structure of the fuel cell of this example. In FIG. 4, the same components as those of Example 1 are denoted by the same reference numerals, so descriptions of the common portions will be omitted.

In FIG. 4, there are provided substrates 90 and 91, an electrode 92, a flow path 93, a flow communication opening 94, a flow path 95, a flow communication opening 96, a closed space 97, a flow path 98, a flow communication opening 99, a flow communication opening 100, a fuel cell unit 101, and a fuel cell 102.

The structure of the fuel cell of this example is basically substantially the same as that of the above Example 1, but is different from that of Example 1 in a structure of the portion where a surface pressure is generated in the fuel cell electrode.

In the fuel cell unit 101 (hereinafter, referred to as cell unit 101) of the present invention, the electrode 92 for taking out electric power (hereinafter, referred to as electrode 92) has the following structure. That is, in the structure, the substrate 91 having, formed therein, the flow paths 93, 95, and 98 through which a fuel gas flows, the flow communication openings 99 and 100, and the closed space 97 for generating a surface pressure is bonded to the substrate 90 having, formed therein, the flow communication openings 94 and 96.

Thus, the fuel gas flowing in through the flow communication openings 25 and 100 reaches the closed space 97 through the flow path 95 to generate a surface pressure. A fuel gas for power generation flows in through the flow communication opening 94 to reach the reaction layer 19. As a result, a surface pressure larger than that of Example 1 can be generated.

A conductance for increasing a pressure in the closed space 97 is preferably maintained in such a relationship that a pressure in the flow path 93 is larger than a pressure in the flow path 95, and the pressure in the flow path 95 is larger than a pressure in the flow communication opening 94.

### EXAMPLE 3

In Example 3, a description will be made of a fuel cell having a form of a stack obtained by stacking cell structures of the fuel cell according to the present invention.

FIG. 5 is a sectional view illustrating a single cell of a fuel cell in a case where the cell structure of the fuel cell according to this example is used in the stack.

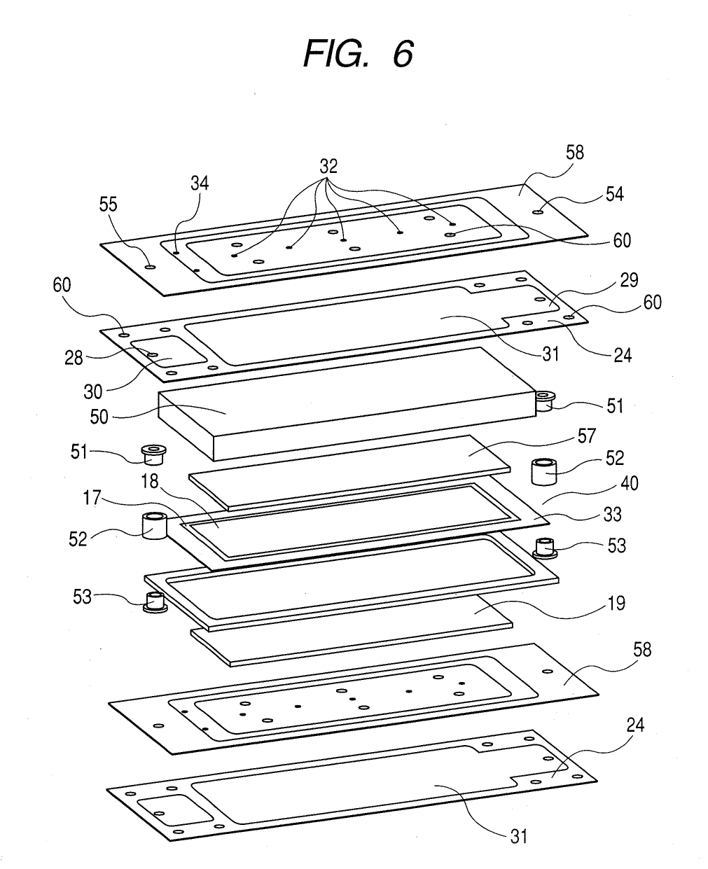

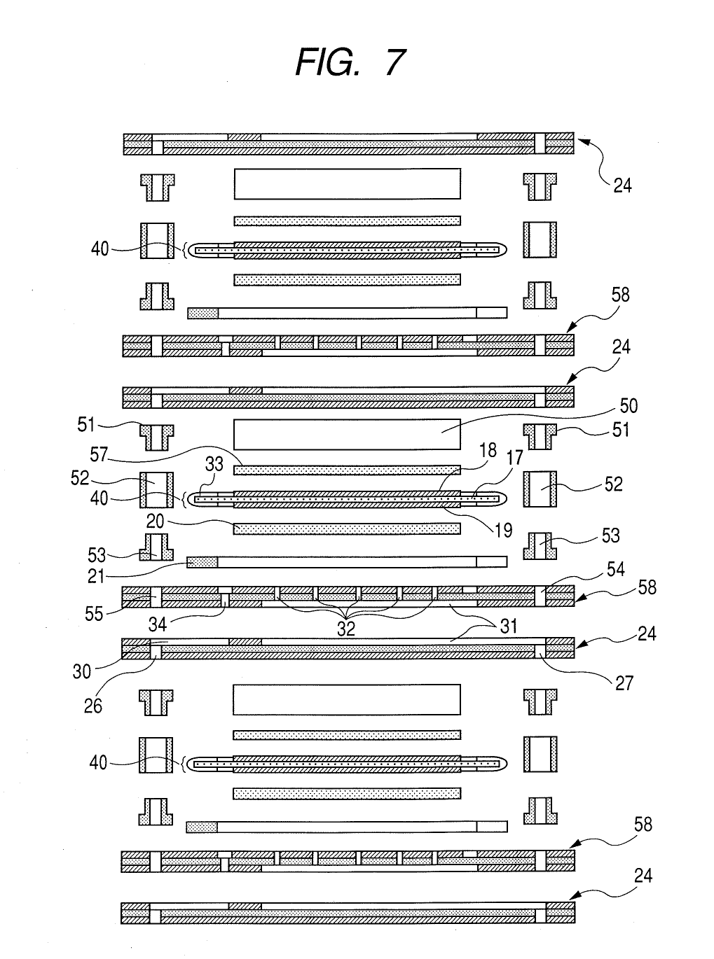

Further, FIG. 6 is an exploded perspective view of the single cell illustrating the fuel cell. FIG. 7 is an exploded sectional view illustrating components in a case where the cell structures of the fuel cell are stacked in several stages.

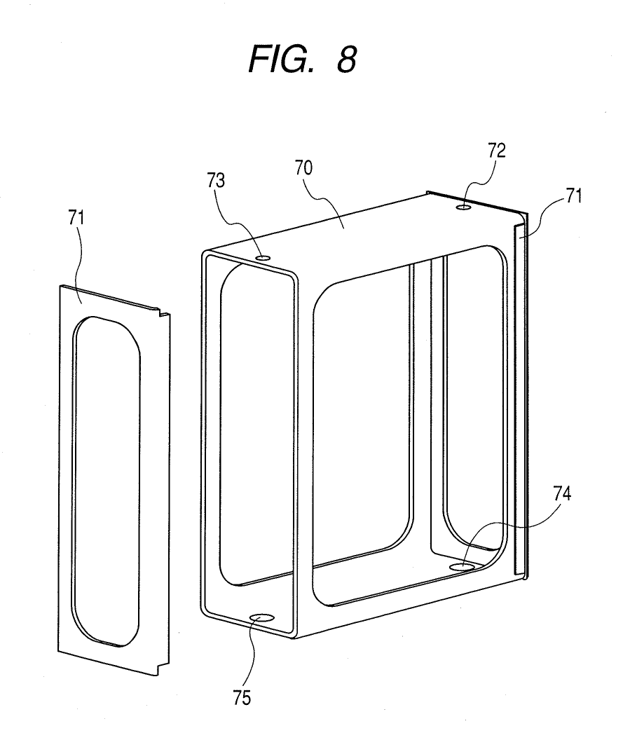

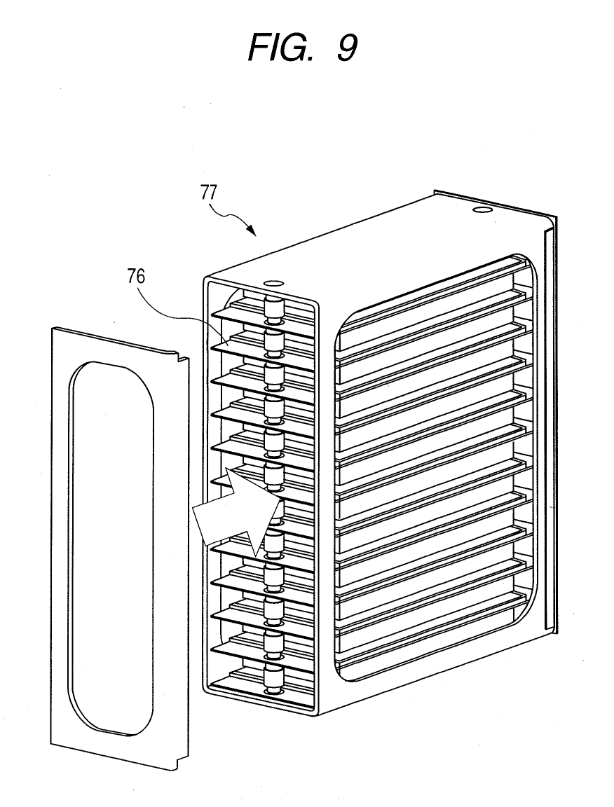

Further, FIG. 8 is a schematic perspective view illustrating a casing for covering the stack obtained by stacking the cell structures of the fuel cell. FIG. 9 is a schematic perspective view illustrating a state when the stack is accommodated in the casing.

In FIGS. 5 to 9, the same components as those of Example 1 or 2 are denoted by the same reference numerals, so that descriptions of the common portions will be omitted.

In FIGS. 5 to 9, there are provided a gas diffusion layer 50, pipes 51, pipes 52, pipes 53, a flow communication opening 54, a flow communication opening 55, and a gas diffusion layer 57.

There are also provided a casing 70, a lid 71, a flow communication opening 72, a flow communication opening 73, a flow communication opening 74, a flow communication opening 75, a fuel cell stack 76, and a fuel cell 77.

The cell structure of the fuel cell for use in the stack obtained by using a fuel cell unit of the present invention is basically substantially the same as that of Example 1 or 2.

The cell units for the stack are stacked, thereby disabling intake of air through the opening portions 35 on the upper surface as described in Examples 1 and 2. Therefore, in order to perform air intake and gas diffusion, the gas diffusion layer 50 is stacked on the MEA 40.

The gas diffusion layer 50 has a function of increasing an amount of intake air, so that an example of a material thereof includes a foamed metal.

Further, in a case where the fuel cell units are stacked, in order to transmit a fuel gas between the cell units, a substrate 58 constituting the fuel cell electrode has flow communication openings 54 and 55 formed therein.

Further, in order to transmit the fuel gas between the cell units, the pipes 51, 52 and 53 are connected to each other.

The pipes 51, 52 and 53 each have a pipe form, however, there may be used a thick substrate having a flow communication opening bored therein or a component obtained by forming a flow path in a flexible substrate.

The components having the above-mentioned structures are stacked in a combination as illustrated in FIG. 7, thereby constituting the fuel cell stack 76.

The fuel cell stack 76 structured as described above is put in the hollow casing 70 having the flow communication openings 72, 73, 74 and 75 formed therein as illustrated in FIG. 8, thereby constituting the fuel cell 77.

The flow communication openings formed in the casing 70 may be closed in some cases according to use conditions.

In order to prevent the fuel cell stack 76 from sticking out of the casing 70 after the fuel cell stack 76 is put therein, opening portions on side surfaces of the casing 70 may be closed by, for example, tapes, detachable lids, metal plate swaging, adhesive, or welding.

In this case, the tapes or the detachable lids are preferable because the fuel cell stack 76 can be taken out afterward.

FIG. 8 schematically illustrates the casing 70 in a case where detachable lids 71 are used.

A function of the fuel cell of this example structured as described above is substantially the same as that of Examples 1 and 2, but is different therefrom in that a fuel gas flows into each of the cell units through the flow communication opening 54 and the pipes 51, 52 and 53.

The fuel gas flowing in allows the flow path 31 (the closed space in a case of using the cell structure of Example 2) of each of the cell units to bulge, thereby pressing the components of the fuel cell to the inner wall of the casing 70, thereby generating the fastening pressure.

As a result, a uniform pressure can be applied by the entire surfaces. Thus, a contact resistance can be reduced.

Further, according to the structure of this example, when the fuel cell stack 76 is taken out of the casing 70, only by cutting off inflow of the fuel gas, the bulge is eliminated. Accordingly, the fuel cell stack 76 can easily be taken out.

### EXAMPLE 4

In Example 4 of the present invention, a description will be made of a modified example in which a cell structure of a fuel cell according to the present invention is used for a stack.

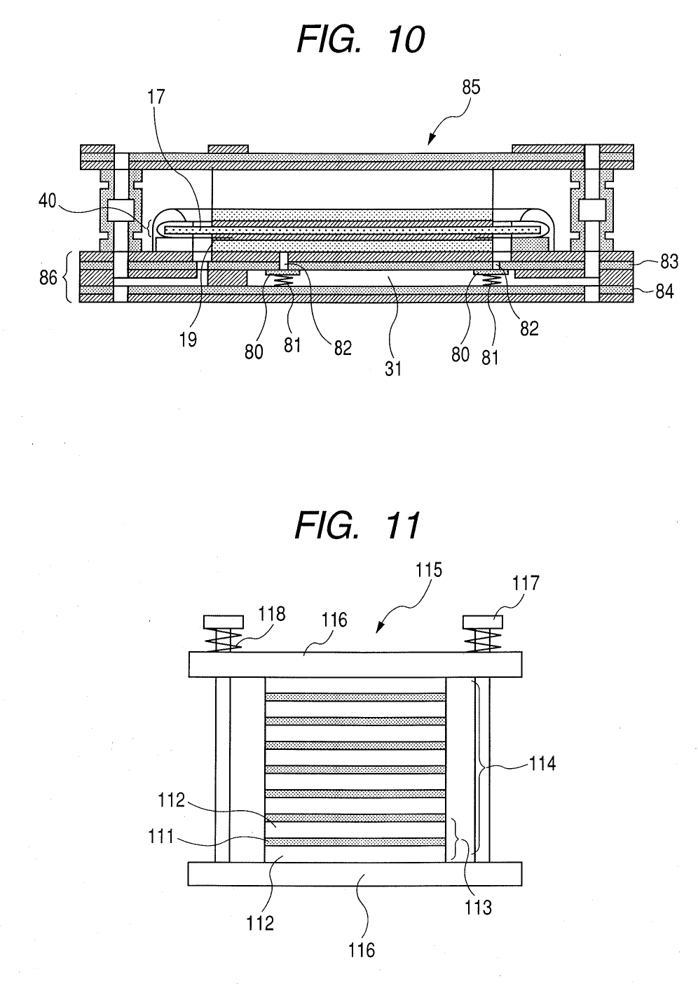

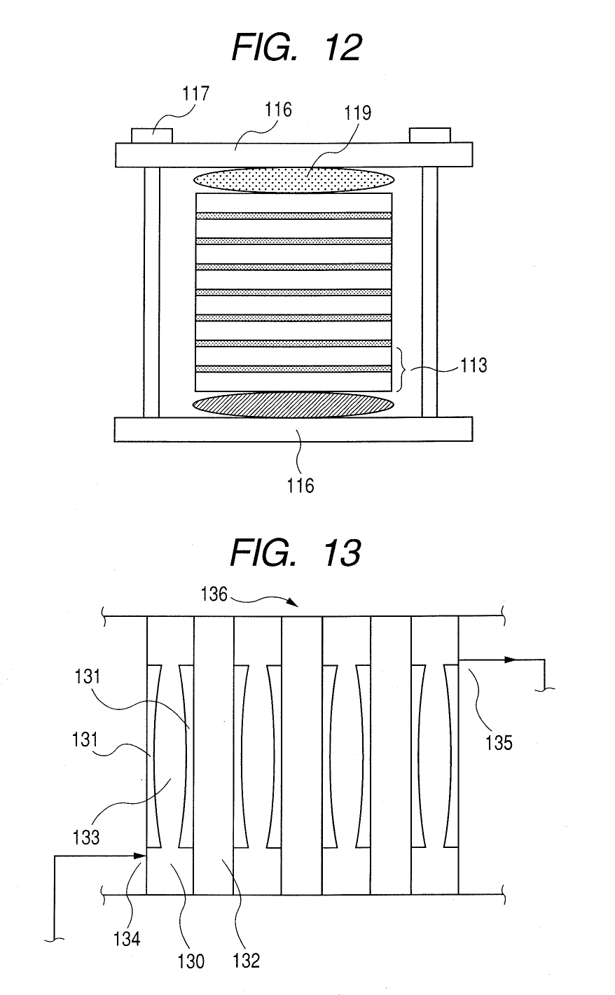

FIG. 10 is a sectional view for illustrating the modified example in which the cell structure of the fuel cell according to this example is used for the stack.

In FIG. 10, the same components as those of Example 1 or 2 are denoted by the same reference numerals, so that descriptions of the common portions will be omitted.

In FIG. 10, there are provided valves 80, springs 81, flow communication openings 82, a substrate 83, a substrate 84, a fuel cell unit 85, and an electrode 86.

The cell structure of the fuel cell of this example is basically substantially the same as Example 1 or 2.

The structure of this example is different from that of Example 1 or 2 which is added with a function as a countermeasure against heat in a case where the fuel cell is made smaller, a function of adjusting a flow rate of the fuel gas flowing in the fuel cell, and the like.

The substrates 83 and 84 constituting the fuel cell electrode 86 are made of an aluminum material having high heat-releasing property, and are each provided with a wiring pattern formed on an aluminum surface by sputtering. The other portions of the surface are subjected to an alumite treatment in order to enhance insulation and environmental characteristics.

The substrate 83 is provided with the flow communication openings 82 for leading the fuel gas from the flow path 31 to the reaction layer 19. An inlet of each of the flow communication openings 82 is provided with the valve 80 for adjusting a pressure of the fuel gas and the spring 81 for pressing opening of the valve 80.

An example of a material of the valve 80 includes a piezoelectric element. The piezoelectric element of the valve 80 mounted to the substrate 83 senses a pressure change, converts the sensed pressure change into an electric signal, and transmits the electric signal to a control circuit (not shown).

In order to maintain a predetermined pressure, by sending a signal for expanding and contracting the piezoelectric element, the pressure of the fuel gas in each of the cell unit can be adjusted.

By using the cell structure of the fuel cell in each of the examples of the present invention as described above, in a case where the components of the fuel cell are stacked, the stable fastening pressure can be applied to the entire surfaces thereof, so that variation in contact resistance, looseness of fastening members caused by expansion and contraction due to heat, and increase in contact resistance can be prevented.

Further, according to the above-mentioned cell structure, a pressurizing surface provided to the electrode bulges, thereby generating the fastening pressure. Accordingly, after the cell structures are put in the casing having a height dimension larger than that of the whole fuel cell units or the stack, by only allowing the fuel gas to flow therein, the fuel cell can be fastened.

As a result, a thickness of an end plate for pressing and supporting the stack and a bolt required for the fastening become unnecessary, so that down-sizing of the fuel cell can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-232865, filed Aug. 29, 2006, which is hereby incorporated by reference herein in its entirety.

1. A cell structure of a fuel cell, comprising:
a fuel cell component including at least an electrolyte membrane having reaction layers formed on both surfaces thereof and a member for allowing gas to diffuse and collecting current at a time of power generation; and
an electrode substrate for taking out electric power, on which the fuel cell component is stacked,
wherein the electrode substrate includes a structural portion for applying a surface pressure to the fuel cell component.

2. The cell structure of a fuel cell according to claim 1, wherein the structural portion for applying the surface pressure is a flow path, which is formed in the electrode substrate, for applying the surface pressure by allowing a fuel gas to flow in the flow path.

3. The cell structure of a fuel cell according to claim 1, wherein the structural portion for applying the surface pressure is a closed space, which is formed in the electrode substrate, for applying the surface pressure by allowing a fuel gas to flow in the closed space.

4. The cell structure of a fuel cell according to claim 2, wherein a unit for adjusting a flow rate of the fuel gas is provided at a flow communication opening for leading the fuel gas to the reaction layers from one of the flow path and the closed space.

5. The cell structure of a fuel cell according to any one of claims 1, wherein the electrode substrate includes a flexible plate-shaped member having at least one of a wiring pattern and a flow path formed thereon.

6. The cell structure of a fuel cell according to any one of claims 1, wherein the electrode substrate includes an aluminum substrate having at least one of a wiring pattern and a flow path formed thereon.

7. The cell structure of a fuel cell according to claim 5, wherein the electrode substrate is formed by bonding a plurality of the plate-shaped members.

8. The fuel cell stack, comprising a plurality of cell structures of fuel cells according to any one of claims 1, wherein the plurality of the cell structures are stacked.

9. The cell structure of a fuel cell according to claim 3, wherein a unit for adjusting a flow rate of the fuel gas is provided at a flow communication opening for leading the fuel gas to the reaction layers from one of the flow path and the closed space.

10. The cell structure of a fuel cell according to claim 6, wherein the electrode substrate is formed by bonding a plurality of the plate-shaped members.
